(19) United States
(12) Patent Application Publication
(10) Pub. No.: US 2009/0260287 A1
(43) Pub. Date: Oct. 22, 2009

(54) Process and Apparatus for the Separation of Methane from a Gas Stream

(75) Inventor: Francis S. Lau, Darien, IL (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GreatPoint Energy, Inc., Chicago, IL (US)

(21) Appl. No.: 12/395,330

(22) Filed: Feb. 27, 2009

Related U.S. Application Data
(60) Provisional application No. 61/032,694, filed on Feb. 29, 2008.

(51) Int. Cl. C10L 3/08; C01B 3/54; C01B 3/32

(52) U.S. Cl. 48/127.7; 422/162; 48/127.3

(57) ABSTRACT

Processes for conversion of a carbonaceous composition into a gas stream comprising methane are provided, where an energy-efficient process and/or apparatus is used to separate methane out of a gas stream comprising methane, carbon monoxide, and hydrogen. Particularly, methane can be separated from hydrogen and carbon monoxide using novel processes and/or apparatuses that generate methane hydrates. Because hydrogen and carbon monoxide do not readily form hydrates, the methane is separated from a gas stream. The methane can be captured as a substantially pure stream of methane gas by dissociating the methane from the hydrate and separating out any residual water vapor.

### CROSS-REFERENCE TO RELATED APPLICATIONS

This application claims priority under 35 U.S.C. § 119 from U.S. Provisional Application Ser. No. 61/032,694 (filed Feb. 29, 2008), the disclosure of which is incorporated by reference herein for all purposes as if fully set forth.

### FIELD OF THE INVENTION

The present invention relates to processes for separating methane from a gas stream that comprises methane and other gases, such as carbon monoxide and hydrogen. Further, the invention relates to an apparatus for separating methane from a gas stream that comprises methane and other gases. Further, the invention relates to processes for converting a carbonaceous composition into a plurality of gaseous products contained in a gas stream, and separating methane from the gas stream.

### BACKGROUND OF THE INVENTION

In view of numerous factors such as higher energy prices and environmental concerns, the production of value-added gaseous products from lower-fuel-value carbonaceous feedstocks, such as biomass, coal and petroleum coke, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/016796 lA1, US2006/0265953A1, US2007/000177A1, US2007/083072A1, US2007/0277437A1 and GB 1599932.

Reaction of lower-fuel-value carbonaceous feedstocks under conditions described in the above references typically yields a crude product gas and a char. The crude product gas typically comprises an amount of particles, which are removed from the gas stream to produce a gas effluent. This gas effluent typically contains a mixture of gases, including, but not limited to, methane, carbon dioxide, hydrogen, carbon monoxide, hydrogen sulfide, ammonia, unreacted steam, entrained fines, and other contaminants such as COS. Through processes known in the art, the gas effluent can be treated to remove carbon dioxide, hydrogen sulfide, steam, entrained fines, COS, and other contaminants, yielding a cleaned gas stream comprising methane, carbon monoxide, and hydrogen.

The cleaned gas stream can be further processed to separate and recover methane by suitable gas separation methods known to those skilled in the art. Known methods include cryogenic distillation and the use of molecular sieves or ceramic membranes. These methods, however, are equipment-intensive and energy-inefficient. Thus, there is a continued need for improved methods and apparatuses for separating methane from other gases in a gas stream.

### SUMMARY OF THE INVENTION

In a first aspect, the present invention provides a process for separating and recovering methane from a gas stream, the process comprising the steps of: (a) providing a gas stream comprising methane, carbon monoxide, and hydrogen; (b) contacting the gas stream with water under suitable temperature and pressure to form a methane-depleted gas stream and a slurry comprising methane hydrate; (c) recovering the slurry; (d) heating the slurry under conditions sufficient to dissociate the methane from the methane hydrate; and (e) recovering the methane under a pressure ranging from about 5 to about 80 atm.

In a second aspect, the present invention provides a process for converting a carbonaceous composition into a plurality of gaseous products contained in a gas stream and separating methane from the gas stream, the process comprising the steps of: (a) supplying a carbonaceous composition to a gasification reactor; (b) reacting the carbonaceous composition in the gasification reactor in the presence of steam and under suitable temperature and pressure to form a gas stream comprising methane and at least one or more of hydrogen, carbon monoxide, carbon dioxide, hydrogen sulfide, ammonia, and other higher hydrocarbons; and (c) separating and recovering the methane from the gas stream in accordance with the process described in the first aspect of the invention.

In a third aspect, the present invention provides an apparatus for separating methane from a gas stream, the apparatus comprising: (a) a mixer configured to receive a gas stream and water and to generate a gas/water mixture, the gas stream comprising methane, carbon monoxide, and hydrogen; (b) a hydrate reactor configured to receive the gas/water mixture, to generate a slurry comprising methane hydrate, and to exhaust a methane-depleted gas stream, the methane depleted gas stream comprising carbon monoxide and hydrogen, the hydrate reactor comprising: a reaction chamber; a gas/water mixture inlet for supplying the gas/water mixture to the reaction chamber, the gas/water mixture inlet in communication with the mixer; a gas outlet for exhausting a methane-depleted gas stream from the reaction chamber; a slurry outlet for removing a slurry from the reaction chamber; and a chiller for cooling the reaction chamber; and (c) a separator configured to receive the slurry comprising methane hydrate, to dissociate the methane from the methane hydrate, and to exhaust methane; the separator comprising: a separation chamber; a slurry inlet for supplying the slurry into the separation chamber, the slurry inlet in communication with the hydrate reactor; a methane gas outlet for exhausting methane from the separation chamber; a water outlet for removing water from the chamber; and a heater for heating the separation chamber.

In a fourth aspect, the invention provides a process for separating and recovering carbon monoxide and hydrogen from a gas stream, the process comprising the steps of: (a) providing a gas stream comprising methane, carbon monoxide, and hydrogen; (b) contacting the gas stream with water under suitable temperature and pressure to form a slurry comprising methane hydrate, and a methane-depleted gas stream comprising carbon monoxide and hydrogen; and (c) recovering the methane-depleted gas stream.

In a fifth aspect, the invention provides a continuous process for converting a carbonaceous feedstock into a plurality of gaseous products, the process comprising the steps of: (a) supplying a carbonaceous feedstock to a gasifying reactor; (b) reacting the carbonaceous feedstock in the gasifying reactor in the presence of steam and a gasification catalyst and under suitable temperature and pressure to form a first gas stream comprising a plurality of gaseous products comprising methane and at least one or more of hydrogen, carbon monoxide, carbon dioxide, hydrogen sulfide, ammonia and other higher hydrocarbons; (c) at least partially separating the plurality of gaseous products to produce a second gas stream comprising methane, carbon monoxide, and hydrogen; (d) separating and recovering a methane-depleted gas stream comprising carbon monoxide and hydrogen in accordance with the process of the fourth aspect of the invention; and (e) recycling at least a portion of the carbon monoxide and hydrogen from the methane-depleted gas stream to the gasifying reactor.

### BRIEF DESCRIPTION OF THE DRAWINGS

FIG. 1 depicts a block diagram that illustrates an embodiment of a methane separation process.

FIG. 2 depicts a block diagram that illustrates a process for converting a carbonaceous composition into methane and other gases, including the separation of methane from a gas stream.

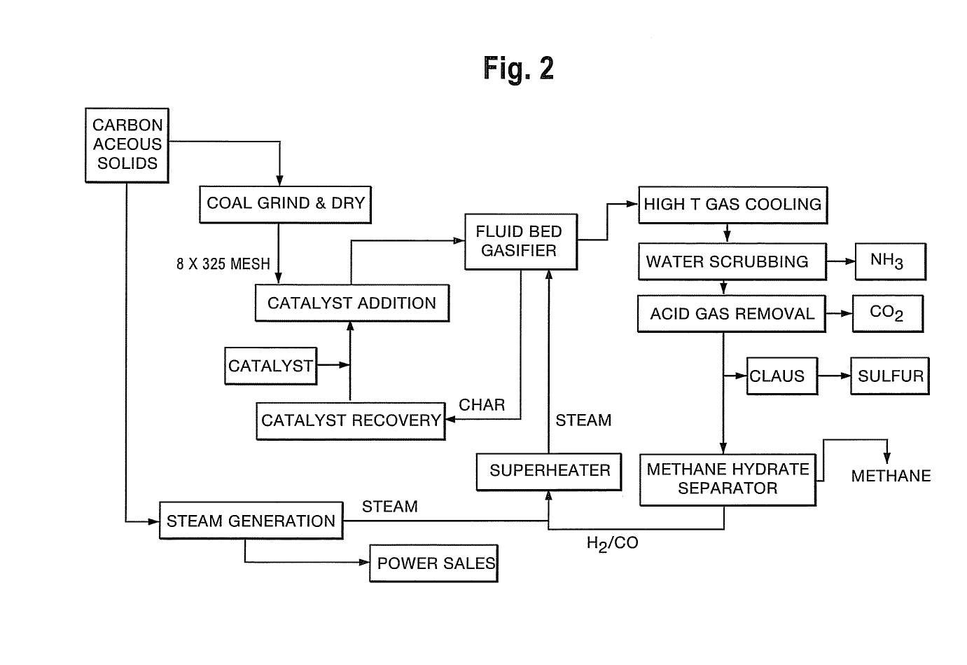

### DETAILED DESCRIPTION

The present invention relates to processes for separating methane from a gas stream, processes for converting a carbonaceous composition into a plurality of gaseous products contained in a gas stream and separating methane from the gas stream, and apparatuses for separating methane from a gas stream. Generally, gasification of a carbonaceous material results in a crude gas stream comprising methane, carbon dioxide, hydrogen, carbon monoxide, hydrogen sulfide, ammonia, unreacted steam, entrained fines, and other contaminants such as COS. Through cleaning operations known to those of skill in the art, the crude gas stream is treated to yield a cleaned gas stream comprising methane, hydrogen, and carbon monoxide. Methane may be used as a clean-burning high-value fuel. Therefore, it is desirable to separate methane from hydrogen, carbon monoxide, and other components in the cleaned gas stream. Cryogenic separation is a typical means of separating methane from a gas stream, but cryogenic separation is equipment-intensive and energy-inefficient. The processes and apparatuses described herein provide for a novel and energy-efficient means of separating methane from other gaseous materials in a gas stream, thus yielding a highly pure stream of methane gas suitable for use, for example, as a fuel.

The present invention can be practiced, for example, using any of the developments to catalytic gasification technology disclosed in commonly owned US2007/0000177A1, US2007/0083072A1 and US2007/0277437A1; and U.S. patent application Ser. Nos. 12/178,380 (filed 23 Jul. 2008), 12/234,012 (filed 19 Sep. 2008) and 12/234,018 (filed 19 Sep. 2008). All of the above are incorporated by reference herein for all purposes as if fully set forth.

Moreover, the present invention can be practiced in conjunction with the subject matter of the following U.S. patent applications, each of which was filed on Dec. 28, 2008: Ser. No. 12/342,554, entitled “CATALYTIC GASIFICATION PROCESS WITH RECOVERY OF ALKALI METAL FROM CHAR”; Ser. No. 12/342,565, entitled “PETROLEUM COKE COMPOSITIONS FOR CATALYTIC GASIFICATION”; Ser. No. 12/342,578, entitled “COAL COMPOSITIONS FOR CATALYTIC GASIFICATION”; Ser. No. 12/342,596, entitled “PROCESSES FOR MAKING SYNTHESIS GAS AND SYNGAS-DERIVED PRODUCTS”; Ser. No. 12/342,608, entitled “PETROLEUM COKE COMPOSITIONS FOR CATALYTIC GASIFICATION”; Ser. No. 12/342,628, entitled “PROCESSES FOR MAKING SYNGAS-DERIVED PRODUCTS”; Ser. No. 12/342,663, entitled “CARBONACEOUS FUELS AND PROCESSES FOR MAKING AND USING THEM”; Ser. No. 12/342,715, entitled “CATALYTIC GASIFICATION PROCESS WITH RECOVERY OF ALKALI METAL FROM CHAR”; Ser. No. 12/342,736, entitled “CATALYTIC GASIFICATION PROCESS WITH RECOVERY OF ALKALI METAL FROM CHAR”; Ser. No. 12/343,143, entitled “CATALYTIC GASIFICATION PROCESS WITH RECOVERY OF ALKALI METAL FROM CHAR”; Ser. No. 12/343,149, entitled “STEAM GENERATING SLURRY GASIFIER FOR THE CATALYTIC GASIFICATION OF A CARBONACEOUS FEEDSTOCK”; and Ser. No. 12/343,159, entitled “CONTINUOUS PROCESSES FOR CONVERTING CARBONACEOUS FEEDSTOCK INTO GASEOUS PRODUCTS”. All of the above are incorporated by reference herein for all purposes as if fully set forth.

Further, the present invention can be practiced in conjunction with the subject matter of the following U.S. patent applications, each of which was filed concurrently herewith: Ser. No. ______, entitled “PROCESSES FOR MAKING ABSORBENTS AND PROCESSES FOR REMOVING CONTAMINANTS FROM FLUIDS USING THEM” (attorney docket no. FN-0019 US NP1); Ser. No. ______, entitled “STEAM GENERATION PROCESSES UTILIZING BIOMASS FEEDSTOCKS” (attorney docket no. FN-0020 US NP1); Ser. No. ______, entitled “REDUCED CARBON FOOTPRINT STEAM GENERATION PROCESSES” (attorney docket no. FN-0021 US NP1); Ser. No. ______, entitled “SELECTIVE REMOVAL AND RECOVERY OF ACID GASES FROM GASIFICATION PRODUCTS” (attorney docket no. FN-0023 US NP1); Ser. No. ______, entitled “COAL COMPOSITIONS FOR CATALYTIC GASIFICATION” (attorney docket no. FN-0024 US NP1); Ser. No. ______, entitled “COAL COMPOSITIONS FOR CATALYTIC GASIFICATION” (attorney docket no. FN-0025 US NP1); Ser. No. ______, entitled “CO-FEED OF BIOMASS AS SOURCE OF MAKEUP CATALYSTS FOR CATALYTIC COAL GASIFICATION” (attorney docket no. FN-0026 US NP1); Ser. No. ______, entitled “COMPACTOR-FEEDER” (attorney docket no. FN-0027 US NP1); Ser. No. ______, entitled “CARBONACEOUS FINES RECYCLE” (attorney docket no. FN-0028 US NP1); Ser. No. ______, entitled “BIOMASS CHAR COMPOSITIONS FOR CATALYTIC GASIFICATION” (attorney docket no. FN-0029 US NP1); Ser. No. ______, entitled “CATALYTIC GASIFICATION PARTICULATE COMPOSITIONS” (attorney docket no. FN-0030 US NP1); and Ser. No. ______, entitled “BIOMASS COMPOSITIONS FOR CATALYTIC GASIFICATION” (attorney docket no. FN-0031 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

When the term “about” is used in describing a value or an end-point of a range, the invention should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

### Gasification Methods

The extraction and recovery methods of the present invention are particularly useful in integrated gasification processes for converting carbonaceous feedstocks, such as petroleum coke, liquid petroleum residue and/or coal to combustible gases, such as methane.

The gasification reactors for such processes are typically operated at moderately high pressures and temperature, requiring introduction of a carbonaceous material (i.e., a feedstock) to the reaction zone of the gasification reactor while maintaining the required temperature, pressure, and flow rate of the feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

The catalyzed feedstock is provided to the catalytic gasifier from a feedstock preparation operation, and generally comprises a particulate composition of a crushed carbonaceous material and a gasification catalyst, as discussed below. In some instances, the catalyzed feedstock can be prepared at pressures conditions above the operating pressure of catalytic gasifier. Hence, the catalyzed feedstock can be directly passed into the catalytic gasifier without further pressurization.

Any of several catalytic gasifiers can be utilized. Suitable gasifiers include counter-current fixed bed, co-current fixed bed, fluidized bed, entrained flow, and moving bed reactors. A catalytic gasifier for gasifying liquid feeds, such as liquid petroleum residues, is disclosed in previously incorporated U.S. Pat. No. 6,955,695.

The pressure in the catalytic gasifier typically can be from about 10 to about 100 atm (from about 150 to about 1500 psig). The gasification reactor temperature can be maintained around at least about 450° C., or at least about 600° C., or at least about 900° C., or at least about 750° C., or about 600° C. to about 700° C.; and at pressures of at least about 50 psig, or at least about 200 psig, or at least about 400 psig, to about 1000 psig, or to about 700 psig, or to about 600 psig.

The gas utilized in the catalytic gasifier for pressurization and reactions of the particulate composition comprises steam, and optionally, oxygen or air, and are supplied, as necessary, to the reactor according to methods known to those skilled in the art.

For example, steam can be supplied to the catalytic gasifier from any of the steam boilers known to those skilled in the art can supply steam to the reactor. Such boilers can be powered, for example, through the use of any carbonaceous material such as powdered coal, biomass etc., and including but not limited to rejected carbonaceous materials from the particulate composition preparation operation (e.g., fines, supra). Steam can also be supplied from a second gasification reactor coupled to a combustion turbine where the exhaust from the reactor is thermally exchanged to a water source and produce steam. Alternatively, the steam may be provided to the gasification reactor as described in previously incorporated U.S. patent application Ser. No. ______, entitled “STEAM GENERATION PROCESSES UTILIZING BIOMASS FEEDSTOCKS” (attorney docket no. FN-0020 US NP1), and Ser. No. ______, entitled “REDUCED CARBON FOOTPRINT STEAM GENERATION PROCESSES” (attorney docket no. FN-0021 US NP1).

Recycled steam from other process operations can also be used for supplementing steam to the catalytic gasifier. For example in the preparation of the catalyzed feedstock, when slurried particulate composition are dried with a fluid bed slurry drier, as discussed below, then the steam generated can be fed to the catalytic gasification reactor.

The small amount of required heat input for the catalytic gasifier can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the catalytic gasifier effluent followed by superheating in a recycle gas furnace.

A methane reformer can be optionally included in the process to supplement the recycle CO and H₂ stream and the exhaust from the slurry gasifier to ensure that enough recycle gas is supplied to the reactor so that the net heat of reaction is as close to neutral as possible (only slightly exothermic or endothermic), in other words, that the catalytic gasifier is run under substantially thermally neutral conditions. In such instances, methane can be supplied for the reformer from the methane product, as described below.

Reaction of the catalyzed feedstock in the catalytic gasifier, under the described conditions, provides a crude product gas and a char from the catalytic gasification reactor.

The char produced in the catalytic gasifier processes is typically removed from the catalytic gasifier for sampling, purging, and/or catalyst recovery in a continuous or batch-wise manner. Methods for removing char are well known to those skilled in the art. One such method taught by EP-A-0102828, for example, can be employed. The char can be periodically withdrawn from the catalytic gasification reactor through a lock hopper system, although other methods are known to those skilled in the art.

Often, the char from the catalytic gasifier is directed to a catalyst recovery and recycle process. Processes have been developed to recover alkali metal from the solid purge in order to reduce raw material costs and to minimize environmental impact of a catalytic gasification process. For example, the char can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512 and US2007/0277437A1, and previously incorporated U.S. patent application Ser. Nos. 12/342,554, 12/342,715, 12/342,736 and 12/343,143. Reference can be had to those documents for further process details.

Upon completion of catalyst recovery, both the char, substantially free of the gasification catalysts and the recovered catalyst (as a solution or solid) can be directed to the feedstock preparation operation comprising a catalyzed feedstock preparation process and a slurry feedstock preparation process.

Crude product gas effluent leaving the catalytic gasifier can pass through a portion of the reactor which serves as a disengagement zone where particles too heavy to be entrained by the gas leaving the reactor (i.e., fines) are returned to the fluidized bed. The disengagement zone can include one or more internal cyclone separators or similar devices for removing fines and particulates from the gas. The gas effluent passing through the disengagement zone and leaving the catalytic gasifier generally contains CH₄, CO₂, H₂ and CO, H₂S, NH₃, unreacted steam, entrained fines, and other contaminants such as COS.

The gas stream from which the fines have been removed can then be passed through a heat exchanger to cool the gas and the recovered heat can be used to preheat recycle gas and generate high pressure steam. Residual entrained fines can also be removed by any suitable means such as external cyclone separators, optionally followed by Venturi scrubbers. The recovered fines can be processed to recover alkali metal catalyst, or directly recycled back to feedstock preparation as described in previously incorporated U.S. patent application Ser. No. ______, entitled “CARBONACEOUS FINES RECYCLE” (attorney docket no. FN-0028 US NP1).

The gas stream from which the fines have been removed can be fed to a gas purification operation comprising COS hydrolysis reactors for COS removal (sour process) and further cooled in a heat exchanger to recover residual heat prior to entering water scrubbers for ammonia recovery, yielding a scrubbed gas comprising at least H₂S, CO₂, CO, H₂, and CH₄. Methods for COS hydrolysis are known to those skilled in the art, for example, see U.S. Pat. No. 4,100,256. The residual heat from the scrubbed gas can be used to generate low pressure steam.

Scrubber water and sour process condensate can be processed to strip and recover H₂S, CO₂ and NH₃; such processes are well known to those skilled in the art. NH₃ can typically be recovered as an aqueous solution (e.g., 20 wt %).

A subsequent acid gas removal process can be used to remove H₂S and CO₂ from the scrubbed gas stream by a physical absorption method involving solvent treatment of the gas to give a cleaned gas stream. Such processes involve contacting the scrubbed gas with a solvent such as monoethanolamine, diethanolamine, methyldiethanolamine, diisopropylamine, diglycolamine, a solution of sodium salts of amino acids, methanol, hot potassium carbonate or the like. One method can involve the use of SELEXOL® (UOP LLC, Des Plaines, Ill. USA) or RECTISOL® (Lurgi A G, Frankfurt am Main, Germany) solvent having two trains; each train consisting of an H₂S absorber and a CO₂ absorber. The spent solvent containing H₂S, CO₂ and other contaminants can be regenerated by any method known to those skilled in the art, including contacting the spent solvent with steam or other stripping gas to remove the contaminants or by passing the spent solvent through stripper columns. Recovered acid gases can be sent for sulfur recovery processing; for example, any recovered H₂S from the acid gas removal and sour water stripping can be converted to elemental sulfur by any method known to those skilled in the art, including the Claus process. Sulfur can be recovered as a molten liquid. Stripped water can be directed for recycled use in preparation of the catalyzed feedstock. One method for removing acid gases from the scrubbed gas stream is described in previously incorporated U.S. patent application Ser. No. ______, entitled “SELECTIVE REMOVAL AND RECOVERY OF ACID GASES FROM GASIFICATION PRODUCTS” (attorney docket no. FN-0023 US NP1).

Advantageously, CO₂ generated in the process, whether in the steam generation or catalytic gasification or both, can be recovered for subsequent use or sequestration, enabling a greatly decreased carbon footprint (as compared to direct combustion of the feedstock) as a result. Processes for reducing a carbon footprint are described in previously incorporated U.S. patent application Ser. No. ______, entitled “STEAM GENERATION PROCESSES UTILIZING BIOMASS FEEDSTOCKS” (attorney docket no. FN-0020 US NP1), and Ser. No. ______, entitled “REDUCED CARBON FOOTPRINT STEAM GENERATION PROCESSES” (attorney docket no. FN-0021 US NP1).

The resulting cleaned gas stream exiting the gas purification operation contains mostly CH₄, H₂, and CO and, typically, small amounts of CO₂ and H₂O.

In accordance with the present invention, this cleaned gas stream can be further processed to separate and recover CH₄ by the methods described herein. Typically, two gas streams can be produced by the gas separation process, a methane product stream and a syngas stream (H₂ and CO).

The syngas stream can be compressed and recycled. One option can be to recycle the syngas steam directly to the catalytic gasifier.

If necessary, a portion of the methane product can be directed to a reformer to provide a ratio of about 3:1 of H₂ to CO in the feed to the catalytic gasification reactor. A portion of the methane product can also be used as plant fuel for a gas turbine.

### Carbonaceous Composition

The term “carbonaceous composition” as used herein includes a carbon source, typically coal, petroleum coke, asphaltene and/or liquid petroleum residue, but may broadly include any source of carbon suitable for gasification, including biomass.

The term “petroleum coke” as used herein includes both (i) the solid thermal decomposition product of high-boiling hydrocarbon fractions obtained in petroleum processing (heavy residues—“resid petcoke”) and (ii) the solid thermal decomposition product of processing tar sands (bituminous sands or oil sands—“tar sands petcoke”). Such carbonization products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % of less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as compounds of silicon and/or aluminum.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

The term “asphaltene” as used herein is an aromatic carbonaceous solid at room temperature, and can be derived, from example, from the processing of crude oil and crude oil tar sands.

The term “liquid petroleum residue” as used herein includes both (i) the liquid thermal decomposition product of high-boiling hydrocarbon fractions obtained in petroleum processing (heavy residues—“resid liquid petroleum residue”) and (ii) the liquid thermal decomposition product of processing tar sands (bituminous sands or oil sands—“tar sands liquid petroleum residue”). The liquid petroleum residue is substantially non-solid at room temperature; for example, it can take the form of a thick fluid or a sludge.

Resid liquid petroleum residue can also be derived from a crude oil, for example, by processes used for upgrading heavy-gravity crude oil distillation residue. Such liquid petroleum residue contains ash as a minor component, typically about 1.0 wt % or less, and more typically about 0.5 wt % of less, based on the weight of the residue. Typically, the ash in such lower-ash residues predominantly comprises metals such as nickel and vanadium.

Tar sands liquid petroleum residue can be derived from an oil sand, for example, by processes used for upgrading oil sand. Tar sands liquid petroleum residue contains ash as a minor component, typically in the range of about 2 wt % to about 12 wt %, and more typically in the range of about 4 wt % to about 12 wt %, based on the overall weight of the residue. Typically, the ash in such higher-ash residues predominantly comprises materials such as compounds of silicon and/or aluminum.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on total coal weight. Examples of useful coals include, but are not limited to, Illinois #6, Pittsburgh #8, Beulah (ND), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art. See, e.g., Coal Data: A Reference, Energy Information Administration, Office of Coal, Nuclear, Electric and Alternate Fuels, U.S. Department of Energy, DOE/EIA-0064(93), February 1995.

The term “ash” as used herein includes inorganic compounds that occur within the carbon source. The ash typically includes compounds of silicon, aluminum, calcium, iron, vanadium, sulfur, and the like. Such compounds include inorganic oxides, such as silica, alumina, ferric oxide, etc., but may also include a variety of minerals containing one or more of silicon, aluminum, calcium, iron, and vanadium. The term “ash” may be used to refer to such compounds present in the carbon source prior to gasification, and may also be used to refer to such compounds present in the char after gasification.

### Catalyst-Loaded Carbonaceous Feedstock

The carbonaceous composition is generally loaded with an amount of an alkali metal compound to promote the steam gasification to methane. Typically, the quantity of the alkali metal compound in the composition is sufficient to provide a ratio of alkali metal atoms to carbon atoms ranging from about 0.01, or from about 0.02, or from about 0.03, or from about 0.04, to about 0.06, or to about 0.07, or to about 0.08. Further, the alkali metal is typically loaded onto a carbon source to achieve an alkali metal content of from about 3 to about 10 times more than the combined ash content of the carbonaceous material (e.g., coal and/or petroleum coke), on a mass basis.

Alkali metal compounds suitable for use as a gasification catalyst include compounds selected from the group consisting of alkali metal carbonates, bicarbonates, formates, oxalates, amides, hydroxides, acetates, halides, nitrates, sulfides, and polysulfides. For example, the catalyst can comprise one or more of Na₂CO₃, K₂CO₃, Rb₂CO₃, Li₂CO₃, Cs₂CO₃, NaOH, KOH, RbOH, or CsOH, and particularly, potassium carbonate and/or potassium hydroxide.

Any methods known to those skilled in the art can be used to associate one or more gasification catalysts with the carbonaceous composition. Such methods include, but are not limited to, admixing with a solid catalyst source and impregnating the catalyst onto the carbonaceous solid. Several impregnation methods known to those skilled in the art can be employed to incorporate the gasification catalysts. These methods include, but are not limited to, incipient wetness impregnation, evaporative impregnation, vacuum impregnation, dip impregnation, and combinations of these methods. Gasification catalysts can be impregnated into the carbonaceous solids by slurrying with a solution (e.g., aqueous) of the catalyst.

That portion of the carbonaceous feedstock of a particle size suitable for use in the gasifying reactor can then be further processed, for example, to impregnate one or more catalysts and/or co-catalysts by methods known in the art, for example, as disclosed in U.S. Pat. No. 4,069,304, U.S. Pat. No. 4,092,125, U.S. Pat. No. 4,468,231, U.S. Pat. No. 4,551,155 and U.S. Pat. No. 5,435,940; and U.S. patent application Ser. Nos. 12/234,012, 12/234,018, 12/342,565, 12/342,578, 12/342,608 and 12/343,159.

One particular method suitable for combining the coal particulate with a gasification catalyst to provide a catalyzed carbonaceous feedstock where the catalyst has been associated with the coal particulate via ion exchange is described in previously incorporated U.S. patent application Ser. No. 12/178,380. The catalyst loading by ion exchange mechanism is maximized (based on adsorption isotherms specifically developed for the coal), and the additional catalyst retained on wet including those inside the pores is controlled so that the total catalyst target value is obtained in a controlled manner. Such loading provides a catalyzed coal particulate as a wet cake. The catalyst loaded and dewatered wet coal cake typically contains, for example, about 50% moisture. The total amount of catalyst loaded is controlled by controlling the concentration of catalyst components in the solution, as well as the contact time, temperature and method, as can be readily determined by those of ordinary skill in the relevant art based on the characteristics of the starting coal.

The catalyzed feedstock can be stored for future use or transferred to a feed operation for introduction into the gasification reactor. The catalyzed feedstock can be conveyed to storage or feed operations according to any methods known to those skilled in the art, for example, a screw conveyer or pneumatic transport.

### Methane Separation Process

As indicated previously, the cleaned gas stream can be further processed to separate methane by the process described below.

1. Providing a Gas Stream

The processes of the invention typically use a gas stream that results from a gasification process, described above. The gas stream comprises methane, carbon monoxide, and hydrogen gases. In some embodiments, the gas stream is a cleaned gas stream, described above, that substantially comprises methane, hydrogen, and carbon monoxide, and, typically, trace amounts of carbon dioxide and water vapor. For example, a gas stream that substantially comprises methane, hydrogen, and carbon monoxide contains less than about 5000 ppm, or less than about 2500 ppm, or less than about 1000 ppm, or less than about 500 ppm, of gas molecules other than methane, hydrogen, or carbon monoxide. In other embodiments, the gas stream is a gas stream that consists essentially of methane, hydrogen, and carbon monoxide. Typically, the gas stream comprises only trace quantities of carbon dioxide. For example, the gas stream may contain less than about 200 ppm, or less than about 100 ppm, or less than about 50 ppm, or less than about 25 ppm, carbon dioxide.

2. Methane Hydrate Formation

The gas stream is contacted with water under suitable temperature and pressure to form a methane-depleted gas stream and a slurry comprising methane hydrate.

As used herein, the term “water” is not restricted to deionized and/or distilled water, but may broadly refer to any aqueous medium that substantially comprises water. For example, “water” includes aqueous media having standard trace amounts of minerals and salts, such as tap water or water taken from natural sources (e.g., underground aquifers, lakes, rivers, streams, reservoirs, oceans, and the like). In some embodiments, the aqueous medium is distilled water.

The gas stream can be contacted with the aqueous medium by any means known to those of skill in the art as suitable for methane hydrate generation. Suitable methods of methane hydrate generation are disclosed, for example, in U.S. Pat. No. 5,536,893, U.S. Pat. No. 6,028,234, U.S. Pat. No. 6,180,843, U.S. Pat. No. 6,653,516, U.S. Pat. No. 6,855,852, US2004/0020123A1 and US2005/0107648A1. In some embodiments, contacting of the gas stream with the water occurs in a hermetically sealed pressure vessel. Water and the gas stream are separately introduced into the pressure vessel in a manner that ensures intimate contact of the gas stream with the water. For example, the gas may be contacted with the liquid by solubilizing the gas under pressure with gas-phase entrainment stirring or bubbling the gas through the liquid. The pressure vessel is equipped with a cooling unit capable of reducing the temperature to levels suitable for generating a methane hydrate slurry. Because hydrogen, carbon monoxide, and other trace gases (e.g., carbon dioxide) will not significantly react with the water to form hydrates under methane hydrate formation conditions, these gases may be exhausted from the pressure chamber through a gas outlet. As the methane hydrate forms (and as hydrogen, carbon monoxide, and other trace gases are exhausted), the pressure is maintained by additional quantities of the gas stream comprising methane, hydrogen, and carbon monoxide. In certain embodiments, the pressure is maintained (at least in later stages of hydrate generation) through the introduction of a gas stream substantially comprising methane, so as to create equilibrium conditions more favorable for hydrate formation.

In other embodiments, for example, contacting of the gas stream is performed using the novel apparatus described below. In such embodiments, the gas stream and the water are initially contacted with each other in a mixer to generate a gas/water mixture. The mixing may occur by any means suitable for creating intimate contact between a gas and a liquid. Suitable methods include, but are not limited to, solubilizing the gas under pressure with gas-phase entrainment stirring or bubbling the gas through the liquid. In some embodiments, pre-chilled water droplets of 50-100 μm size are sprayed into a mixer and make contact with a feed gas. In some embodiments, the feed gas is fed through a feeder at about 500 psi. The resulting gas/water mixture is then transferred to a hydrate reactor, described below. In the hydrate reactor, the gas/liquid mixture is subjected to temperature and pressure conditions suitable for methane hydrate generation.

As used herein, the term “methane hydrate” (in singular or plural form) refers broadly to hydrated forms of methane that exist in solid state. Methane hydrates include, but are not limited to, inclusion compounds or clathrate compounds in a crystalline structure results from the inclusion of methane in an inclusion lattice (clathrate) of water molecules. Hydrated methane, may, for example, exist as a stable solid at −30° C. and at atmospheric pressures, and occupies a volume approximately less than 1% of the volume of gaseous methane. Other hydrocarbons, e.g., ethane and propane, and carbon dioxide may form hydrates as well. To the degree that trace quantities of these higher hydrocarbons are present in the gas stream, the term “methane hydrate” may describe a composition in which hydrates of other hydrocarbons and/or carbon dioxide are present in trace amounts.

Because methane hydrates exist in the solid state, when generated in the presence of an excess of water, a slurry results. The slurry comprises liquid water and solid methane hydrates. Prior to exhaustion of hydrogen, carbon monoxide, and other non-hydrate-forming gases, the slurry may also comprise trace quantities of these gases dissolved therein. Additionally, the resulting slurry may, in some instances, comprise amounts of solid water (i.e., ice), depending on the temperature and pressure conditions under which the methane hydrate-comprising slurry is generated. Characteristics of methane hydrate-comprising slurries are described in greater detail in previously incorporated US2004/0020123A1 and US2005/0107648A1.

The gas stream is contacted with water under suitable temperature and pressure to form a methane-depleted gas stream and a slurry comprising methane hydrate. This “contacting” step, as partially discussed above, broadly encompasses the process of methane hydrate generation, such as mixing of the water and the gas stream prior to transfer to the hydrate reactor. Thus, the invention encompasses embodiments where the gas stream and the water do not initially contact each other under suitable temperature and pressure to form a methane-depleted gas stream and a slurry comprising methane hydrate. Nevertheless, at some point while the gas stream and the water are in contact with each other, the gas/liquid mixture is subjected to suitable temperature and pressure to form a methane-depleted gas stream and a slurry comprising methane hydrate. In some embodiments, such suitable conditions may exist almost immediately upon contact between the gas stream and the water. In other embodiments, one or more preparation steps (e.g., mixing of the gas stream with the water in a mixer separate from the hydrate reactor) may precede the application of conditions suitable for forming the hydrate slurry and the methane-depleted gas stream. Additionally, these suitable conditions need not prevail at all times during the generation of the methane hydrate slurry. In some embodiments, for example, the hydrate reactor may be at least partially depressurized at intermittent points to exhaust the methane-depleted gas stream. Following exhaust of the methane-depleted gas stream, the hydrate reactor may again be pressurized (e.g., by addition of further amounts of the gas stream comprising methane, carbon monoxide, and hydrogen, or by addition of a methane-enriched gas stream) to achieve conditions suitable for forming a methane-depleted gas stream and a slurry comprising methane hydrate.

Suitable temperatures for forming a methane-depleted gas stream and a slurry comprising methane hydrate range from about −50° C., or from about −40° C., or from about −30° C., or from about −20° C., to about −10° C., or to about 0° C. In some embodiments, the temperature is about 0° C., or about −5° C., or about −10° C. Suitable pressures for forming a methane-depleted gas stream and a slurry comprising methane hydrate range from about 10 atm, or from about 20 atm, or from about 25 atm, to about 40 atm, or to about 50 atm, or to about 60 atm. In some embodiments, the pressure is about 35 atm, or about 40 atm, or about 45 atm.

The methane-depleted gas largely comprises hydrogen and carbon monoxide, but may also comprise small quantities of gaseous methane. For example, the methane-depleted gas comprises less than about 5 mol % of methane, or less than about 3 mol % methane, or less than about 1 mol % methane. In some embodiments, the methane-depleted gas stream is recovered upon exhaust from the hydrate reactor. For example, the methane-depleted gas can be pumped from the hydrate reactor into a suitable collection chamber (e.g., a storage tank). In catalytic gasification processes described above, hydrogen and carbon monoxide can be used as part of the fuel source for the gasification reactor. Therefore, in some embodiments, at least a portion of the recovered the methane-depleted gas, which may substantially comprise hydrogen and carbon monoxide, is recycled back into the gasification reactor.

The low temperatures may be maintained by any standard cooling unit known to those of skill in the art. The hydrate reactor is typically equipped with at least one cooling unit. In some embodiments, however, the gas/water mixture is passed through a cooling unit (e.g., a chiller) after leaving the mixer but before entering the hydrate reactor.

In some embodiments, the water used for contacting the gas stream comprises a promoter. Use of promoters in hydrate generation is known in the art and is discussed in further detail in, for example, U.S. Pat. No. 6,389,820 and U.S. Pat. No. 6,602,326. Suitable hydrate promoters include, but are not limited to acetone, propylene oxide, 1,4-dioxane, tetrahydrofuran (THF), and surfactants, such as alkyl sulfates (e.g., sodium lauryl sulfate), alkyl ether sulfates, alkyl sulfonates, and alkyl aryl sulfonates. Appropriate concentrations of promoters will vary with the promoter used. For example, the concentration of the promoter in the water can be up to about 2 mol %, or up to about 1 mol %, or up to about 0.5 mol %.

When the water comprises a promoter, the methane hydrate can be generated at higher temperatures and at lower pressures than would be required for hydrate generation in the absence of the promoter. Suitable temperatures and pressures depend on a variety of factors including, but not limited to, the composition of the promoter and the concentration of the promoter in the water. When the water comprises a promoter, suitable temperatures for forming a methane-depleted gas stream and a slurry comprising methane hydrate range from about −20° C., or from about −10° C., to about 5° C., or to about 10° C. In some embodiments, the temperature is about 0° C., or about −5° C., or about 5° C. Suitable pressures for forming a methane-depleted gas stream and a slurry comprising methane hydrate range from about 5 atm, or from about 10 atm, or from about 15 atm, to about 20 atm, or to about 30 atm, or to about 40 atm. In some embodiments, the pressure is about 15 atm, or about 20 atm, or about 25 atm.

3. Recovery of the Methane Hydrate Slurry

Following generation of the methane hydrate slurry, the slurry may be recovered. In typical embodiments, the recovery process includes draining of the slurry through a slurry outlet (e.g., a closeable aperture) in the reaction chamber that was used to generate the slurry. In some embodiments, such an aperture is placed on the side of the reaction vessel. Because the methane hydrate is less dense than liquid water, the methane hydrate will tend to float, and can therefore be removed more efficiently through the side of the chamber. The aperture need not be situated on the side of the reaction vessel, however. The methane hydrate slurry may be collected in any apparatus capable of receiving and holding the slurry. In some embodiments, the slurry may be transferred from the hydrate reactor to this receiving apparatus via a pipe or other conduit-like devices. In some embodiments, a slurry pump is used to pump the hydrate slurry from the reactor. In some embodiments, the methane hydrate slurry is transferred directly to a separator configured to receive the slurry, to dissociate the methane from the methane hydrate, and to exhaust methane.

In some embodiments, the recovered slurry is subjected to a dewatering step to remove some or nearly all of the excess water so that the methane hydrate may be transported to a location remote from the site of hydrate generation. Useful dewatering methods are disclosed in previously incorporated US2004/0020123A1 and US2005/0107648A1. In some embodiments, dewatering may be accomplished by gravity filtration and/or by use of a fluid press. Dewatering concentrates the methane hydrate and reduces the overall mass. The dewatered methane hydrate can be readily transported as a solid material, so long as appropriate conditions are maintained (e.g., atmospheric pressure and about −30° C.).

4. Dissociation of Methane from Methane Hydrate

The slurry comprising the methane hydrate is heated under conditions sufficient to dissociate the methane from the methane hydrate. When methane hydrate (either in a slurry or in dewatered form) is heated, the hydrate dissociates, thereby forming methane gas and water.

In embodiments where the slurry is not dewatered, the recovered slurry may be heated under conditions sufficient to dissociate the methane from the methane hydrate. For example, the recovered slurry may be heated to temperatures above about 10° C., or above about 20° C., or above about 25° C., or above about 30° C., or above about 35° C. The process is typically carried out at about atmospheric pressure, although higher or lower pressures can be suitable as well. In some embodiments, the slurry is heated to about 30° C. at about atmospheric pressure.

In embodiments where the slurry has been dewatered, lower temperatures may be suitable for dissociating the methane from the methane hydrate. For example, the dewatered methane hydrate may be heated to temperatures above about 0° C., or above about 10° C., or above about 20° C., or above about 30° C. The process is typically carried out at about atmospheric pressure, although higher or lower pressures can be suitable as well. In some embodiments, the slurry is heated to about 20° C. at about atmospheric pressure.

After heating, the methane gas separates from the slurry and collects as a gas above the water within the unit used to dissociate the methane from the hydrate. In some embodiments, the methane (and small amounts of water vapor) exists in gaseous form within a separator unit, where the separator unit is equipped with a methane gas outlet for exhausting the methane (and trace amounts of water vapor) from the separation chamber.

The heating may be carried out by any standard heating unit known to those of skill in the art. In some embodiments, however, the methane hydrate slurry may pass through a heating unit after leaving the hydrate reactor and before entering the separator.

5. Recovery of Methane Gas

After separation from the hydrate, the methane gas is recovered. The methane gas may be removed from the separator by any suitable means known to those of skill in the art. For example, in some embodiments, a compressor is used to withdraw the gaseous methane from the separator.

Because water is present in the separator, the withdrawn methane stream will also have trace amounts of water vapor. The water can be separated from the methane using standard techniques known to those of skill in the art.

Following collection, the methane is typically compressed using a suitable gas compressor to a pressure ranging from about 1 atm, or from about 3 atm, or from about 5 atm, or from about 10 atm, from about 20 atm, or from about 30 atm, or from about 40 atm, or from about 50 atm, to about 50 atm, or to about 60 atm, or to about 70 atm, or to about 80 atm. In some embodiments, the methane is compressed to about 70 atm.

One can potentially recover methane at the final pressure so compression is not needed by pumping the methane hydrate slurry via a pump, as it is much more energy efficient to compress water/slurry than compress gas to high pressure.

Further process details can be had by reference to the previously incorporated patents and publications.

Apparatus for Separating Methane from a Gas Stream

In some embodiments, the methane separation process, described above, may suitably make use of a novel apparatus for separating methane from a gas stream. The apparatus comprises three primary chambers: a mixer, a hydrate reactor, and a separator. In general, these components and any valves, pipes, conduits, connectors, and the like that permit communication between these components are made of materials that are suitable for exposure to methane gas (e.g., does not corrode or break down when exposed to methane).

1. Mixer

The mixer is configured to receive a gas stream and water and to generate a gas/water mixture. Suitable mixers are commercially available, and include mixers made of materials that are compatible for use with methane gas.

In some embodiments, the water (which may or may not include a promoter, as discussed above) is introduced into a mixing chamber through a water inlet. For example, the water can be introduced by using a pump to spray pre-chilled water droplets of about 50-100 μm size into the mixer through the water inlet. In some embodiments, a gas stream comprising methane, carbon monoxide, and hydrogen is introduced into the mixing chamber through a gas stream inlet that supplies a gas stream to the mixing chamber.

In some instances, the large surface area of the water droplets and the rapid gas stream flow rate create a situation where the gas stream and the water become intimately mixed without the use of a physical mixing element. In other embodiments, a mixing element is used. Suitable methods for mixing include, but are not limited to, solubilizing the gas under pressure with gas-phase entrainment stirring or bubbling the gas through the liquid.

In some embodiments, the mixer comprises a chiller that cools the water (e.g., to about 10° C.) before spraying the water into the mixing chamber. Additionally, in some embodiments, the apparatus comprises a pump that pumps the water from a water source (e.g., a tank) to the mixer.

2. Hydrate Reactor

The hydrate reactor is configured to receive the gas/liquid mixture (e.g., from the mixer), to generate a slurry comprising methane hydrate, and to exhaust a methane-depleted gas stream. Suitable reactors are commercially available, and include reactors made of materials that are compatible for use with methane gas.

The hydrate reactor comprises a reaction chamber that is capable of maintaining conditions for methane hydrate generation. In typical embodiments, methane hydrates are generated at temperatures below room temperature and at pressures above atmospheric pressure. Therefore, a typical reaction chamber is capable of maintaining elevated pressures of up to about 70 atm, or up to about 50 atm, or up to about 35 atm, or up to about 20 atm. A typical reaction chamber is also suitable for maintaining cooler temperatures of about −20° C. or lower, or of about −30° C. or lower, or of about −40° C. or lower, or of about −50° C. or lower.

The hydrate reactor is also equipped with a gas/water inlet that supplies the gas/water mixture from the mixer into the reaction chamber, where the gas/water inlet is in communication with the reaction chamber. In some embodiments, the gas/water inlet is an aperture through which the gas/water mixture may flow. Additionally, some embodiments include a pump between the mixer and the reaction chamber, where the pump assists the flow of the gas/water mixture through the gas/water inlet into the reaction chamber. In typical embodiments, the gas/water inlet can be opened and closed to provide control of the influx of gas/water mixture into the chamber and to increase the ease of achieving elevated pressures within the chamber.

The hydrate reactor is further equipped with a gas outlet for exhausting a methane-depleted gas from the reaction chamber. Because hydrogen, carbon monoxide, and other gases do not readily form hydrates, they can be removed from the reaction chamber after much of the methane has reacted to form solid methane hydrates in the slurry. The methane-depleted gas largely comprises hydrogen and carbon monoxide, but may also comprise small quantities of gaseous methane. For example, the methane-depleted gas comprises less than about 5 mol % of methane, or less than about 3 mol % methane, or less than about 1 mol % methane. In typical embodiments, the gas outlet is an aperture that can be opened and closed. In some embodiments, the gas outlet is in communication with a gas reservoir that permits the collection of the methane-depleted gas, which can be used for other useful purposes in the gasification process. This gas outlet need not function exclusively as an exhaust outlet for a methane-depleted gas. In some embodiments, it can be useful to pressurize the reaction chamber with a methane-enriched gas stream, where an excess of methane is used to drive the equilibrium toward hydrate formation. In such embodiments, the same gas outlet can be used to exhaust this gas, even though this gas is not a methane-depleted gas.

The hydrate reactor is equipped with a slurry outlet that permits the hydrate slurry to leave the reaction chamber. In typical embodiments, the slurry outlet is an aperture that can be opened and closed. In some embodiments, such an aperture is placed on the side of the reaction vessel. Because the methane hydrate is less dense than liquid water, the methane hydrate will tend to float, and can therefore be removed more efficiently through the side of the chamber. The aperture need not be situated on the side of the reaction vessel, however. In some embodiments, the slurry outlet is configured to provide direct communication with a separator. In other embodiments, the apparatus can employ a slurry pump that assists in withdrawing the hydrate slurry from the hydrate reactor.

The hydrate reactor is equipped with a chiller capable of cooling the reaction chamber to temperatures that are suitable for methane hydrate generation. Any cooling apparatus capable of achieving and maintaining suitable temperatures would be suitable. The suitability of a particular chiller will depend, for example, on the volume of the reaction chamber, the temperature of the gas/liquid mixture entering the reaction chamber, and the degree of thermal insulation of the reaction chamber. A typical chiller, for example, is capable of cooling and maintaining the contents of the reaction chamber to temperatures of about 0° C. or lower, or of about −10° C. or lower, or of about −20° C. or lower, or of about −30° C. or lower, or of about −40° C. or lower, or of about −50° C. or lower. In some embodiments, the chiller is external to the reaction chamber, but external placement is not necessary. Additionally, in some embodiments, the gas/water mixture may pass through a chiller prior to entering the hydrate reactor.

3. Separator

The separator is configured to receive the methane hydrate slurry, to dissociate the methane from the methane hydrate, and to exhaust methane. Suitable separators are commercially available, and include separators made of materials that are compatible for use with methane gas.

The separator comprises a separation chamber that is capable of creating and maintaining conditions for dissociation of the methane hydrate. A typical separation chamber is suitable for maintaining temperatures above about 10° C., or above about 20° C., or above about 25° C., or above about 30° C., or above about 35° C. In typical embodiments, the separation process is carried out at about atmospheric pressure, although higher or lower pressures can be suitable as well. Therefore, the separation chamber need not be designed to withstand lower or higher pressures, although some embodiments can include separation chambers designed to withstand pressures higher and/or lower than atmospheric pressure.

The separator is equipped with a slurry inlet that supplies the slurry into the separation chamber. In typical embodiments, the slurry inlet is an aperture that may be opened and closed. The slurry inlet can be in direct communication with the hydrate reactor. In some embodiments, though, the slurry inlet is in communication with a slurry pump that assists in pumping the hydrate slurry from the hydrate reactor to the separator. Thus, the communication with the hydrate reactor can be indirect.

The separator is equipped with a methane gas outlet for exhausting methane from the separation chamber. In typical embodiments, the methane gas outlet is an aperture that can be opened and closed. In some embodiments, the methane gas outlet is in communication with a gas reservoir that permits the collection of the methane. The gas that exhausts through the methane gas outlet, typically comprises a small amount of water vapor. Therefore, in some embodiments, the methane gas outlet is in communication with an apparatus capable of separating the water vapor from the methane-rich stream of gas.

The separator is equipped with a water outlet for removing water from the chamber. The water outlet is typically an aperture that is capable of being open and closed. In some embodiments, the water outlet is in the bottom of the separation chamber, such that the water is removed from the chamber by gravity when the water outlet is opened. In some embodiments, the water outlet can be in communication with a pump or other like device for assisting in the removal of water from the chamber.

The separator is equipped with a heater for heating the separation chamber. Because the methane hydrate slurry enters the separator as a chilled substance, the slurry is heated to effect the dissociation of the methane from the hydrate. One of skill in the art is capable of selecting a heater that is appropriate for the volume of slurry entering the chamber, the temperature of the chilled hydrate slurry, the desired degree of heating, and the time constraints of the process. In some embodiments, for example, placing the separator in a room-temperature (e.g., about 25° C.) environment serve as the heater. In typical embodiments, however, the separation chamber is heated by a heat-generating device that is either external or internal to the separation chamber. The heater should be capable of heating the volume of slurry to a temperature above about 10° C., or above about 20° C., or above about 25° C., or above about 30° C., or above about 35° C. Additionally, in some embodiments, the hydrate slurry may pass through a heater prior to entering into the separator.

### EXAMPLE

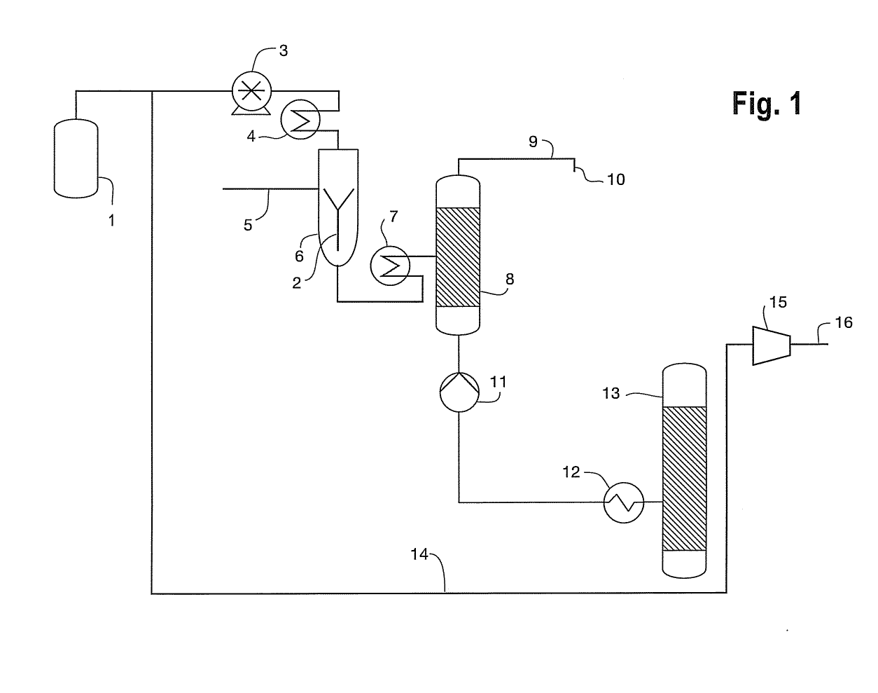

A carbonaceous composition can be reacted in a gasification reactor in the presence of steam to yield a gas stream that includes methane, hydrogen, carbon monoxide, and other gases such as carbon dioxide, hydrogen sulfide, ammonia, and higher hydrocarbons. The gas stream is then substantially purified of all gases except for methane, carbon monoxide, and hydrogen. The gas stream comprising methane, carbon monoxide, and hydrogen is then delivered to an apparatus (shown in FIG. 1) for separating methane from carbon monoxide and hydrogen.

Water comprising a promoter (e.g., THF) is stored in a water storage reservoir (1) and is supplied to a mixer (2) via a pump (3). Between the pump (3) and the mixer (2), the water passes through a chiller (4) to cool the water in advance of its introduction into the mixer (2) as droplets of 50-100 μm size. The feed gas (5) from the gasification process comprising methane, hydrogen, and carbon monoxide enters the mixer (2) through a separate inlet from the water. The water droplets and the gas stream are mixed in the mixer (2) using a paddle system (6) which assists in the mixing of the gas stream with the water. Upon leaving the mixer (2), the gas/liquid mixture is passed through another chiller (7) which further reduces the temperature of the gas/liquid mixture. After passing through the second chiller (7), the gas/liquid mixture is released into the hydrate reactor (8). As the methane hydrate forms, the pressure within the hydrate reactor 8 is maintained by the addition of additional feed gas through a feed gas inlet (not shown) and/or by the addition of methane or a methane-enriched feed gas (not shown). At intervals, a methane-depleted gas stream comprising hydrogen and carbon monoxide is released through an exhaust (9). This methane-depleted gas is carried through the exhaust (9) to a separator unit (10) for separating the carbon monoxide from hydrogen. The methane hydrate slurry is pumped out of the hydrate reactor (8) using a slurry pump (11), and then passed through a heater (12) before entering the separator (13). After separation of the methane from water, the water is collected into a pipe (14) and is pumped back into the mixer (2) using a pump (3). The methane that is separated leaves the separator (13) and is passed through a compressor (15) and then is released into a pipeline (16) as a compressed gas.

We claim:

1. An apparatus for separating methane from a gas stream, the apparatus comprising:
(a) a mixer configured to receive a gas stream and water and to generate a gas/water mixture, the gas stream comprising methane, carbon monoxide, and hydrogen;
(b) a hydrate reactor configured to receive the gas/water mixture, to generate a slurry comprising methane hydrate, and to exhaust a methane-depleted gas stream, the methane-depleted gas stream comprising carbon monoxide and hydrogen, the hydrate reactor comprising:
a reaction chamber;
a gas/water mixture inlet for supplying the gas/water mixture to the reaction chamber, the gas/water mixture inlet in communication with the mixer;
a gas outlet for exhausting a methane-depleted gas stream from the reaction chamber;
a slurry outlet for removing a slurry from the reaction chamber; and
a chiller for cooling the reaction chamber; and
(c) a separator configured to receive the slurry comprising methane hydrate, to dissociate the methane from the methane hydrate, and to exhaust methane, the separator comprising:
a separation chamber;
a slurry inlet for supplying the slurry into the separation chamber, the slurry inlet in communication with the hydrate reactor;
a methane gas outlet for exhausting methane from the separation chamber;
a water outlet for removing water from the chamber; and
a heater for heating the separation chamber.

2. The apparatus according to claim 1, wherein the mixer comprises:
a mixing chamber;
a gas stream inlet for supplying a gas stream to the mixing chamber;
a water inlet for supplying water to the mixing chamber;
a gas/water outlet for removing the gas/water mixture from the mixing chamber;
a mixing element for mixing the gas stream and water in the mixing chamber to form a gas/water mixture; and
a chiller for cooling the water entering the mixer.

3. The apparatus according to claim 1, further comprising a water source in communication with the mixer, the separator, or both.

4. The apparatus according to claim 1, further comprising a gas stream source in communication with the mixer.

5. The apparatus according to claim 4, further comprising a pump for pumping water from the water source to the mixer.

6. The apparatus according to claim 1, further comprising a pump for pumping slurry from the hydrate reactor to the separator.

7. A process for separating and recovering methane from a gas stream, the process comprising the steps of:
(a) providing a gas stream comprising methane, carbon monoxide and hydrogen;
(b) contacting the gas stream with water under suitable temperature and pressure to form a methane-depleted gas stream and a slurry comprising methane hydrate;
(c) recovering the slurry;
(d) heating the slurry under conditions sufficient to dissociate the methane from the methane hydrate; and
(e) recovering the methane under a pressure ranging from about 5 to about 80 atm.

8. The process according to claim 7, wherein step (b) is performed at a temperature ranging from about −50° C. to about 0° C. and at a pressure ranging from about 10 atms to about 60 atms.

9. The process according to claim 7, wherein step (d) is performed at a temperature above about 0° C., and at a pressure of about atmospheric pressure or above.

10. The process according to claim 7, wherein the step (b) water comprises a promoter.

11. The process according to claim 10, wherein the promoter is selected from the group consisting of tetrahydrofuran, 1,4-dioxane, and sodium lauryl sulfate.

12. The process according to claim 10, wherein step (b) is performed at a temperature ranging from about −20° C. to about 10° C. and at a pressure ranging from about 5 atms to about 40 atms.

13. A process for converting a carbonaceous composition into a plurality of gaseous products contained in a gas stream and separating methane from the gas stream, the process comprising the steps of:
(a) supplying a carbonaceous composition to a gasification reactor;
(b) reacting the carbonaceous composition in the gasification reactor in the presence of steam and under suitable temperature and pressure to form a gas stream comprising methane and at least one or more of hydrogen, carbon monoxide, carbon dioxide, hydrogen sulfide, ammonia, and other higher hydrocarbons; and
(c) separating and recovering methane from the gas stream in accordance with the process of claim 7.

14. A process for separating and recovering carbon monoxide and hydrogen from a gas stream, the process comprising the steps of:
(a) providing a gas stream comprising methane, carbon monoxide, and hydrogen;
(b) contacting the gas stream with water under suitable temperature and pressure to form a slurry comprising methane hydrate, and a methane-depleted gas stream comprising carbon monoxide and hydrogen; and
(c) recovering the methane-depleted gas stream.

15. A continuous process for converting a carbonaceous feedstock into a plurality of gaseous products, the process comprising the steps of:
(a) supplying a carbonaceous feedstock to a gasifying reactor;
(b) reacting the carbonaceous feedstock in the gasifying reactor in the presence of steam and a gasification catalyst and under suitable temperature and pressure to form a first gas stream comprising a plurality of gaseous products comprising methane and at least one or more of hydrogen, carbon monoxide, carbon dioxide, hydrogen sulfide, ammonia and other higher hydrocarbons;
(c) at least partially separating the plurality of gaseous products to produce a second gas stream comprising methane, carbon monoxide, and hydrogen;
(d) separating and recovering a methane-depleted gas stream comprising carbon monoxide and hydrogen in accordance with the process of claim 14; and
(e) recycling at least a portion of the carbon monoxide and hydrogen from the methane-depleted gas stream to the gasifying reactor.
